(19) United States
(12) Patent Application Publication
(10) Pub. No.: US 2025/0245617 A1
(43) Pub. Date: Jul. 31, 2025

(54) PROVIDING DEVICE, PROVIDING METHOD, AND NON-TRANSITORY RECORDING MEDIUM

(71) Applicant: Rakuten Group, Inc., Tokyo (JP)

(72) Inventor: Taishin MURASE, Tokyo (JP)

(73) Assignee: Rakuten Group, Inc., Tokyo (JP)

(21) Appl. No.: 19/063,508

(22) Filed: Feb. 26, 2025

(30) Foreign Application Priority Data
Jan. 29, 2024 (JP) 2024-030671

(51) Int. Cl. G06Q 10/0835; G01C 21/00

(52) U.S. Cl. CPC G06Q 10/08355; G01C 21/3807

(57) ABSTRACT

A providing device includes: an accepter to accept an address character string; an acquirer to acquire latitude-longitude information associated with the accepted address character string; an extractor to extract position information recorded in association with the accepted address character string from a database; a determiner to determine whether or not the latitude-longitude information is correct; and a provider to provide, when the latitude-longitude information is determined to be correct, delivery-destination map information in which a position determined based on the latitude-longitude information is displayed on a map and provide, when the latitude-longitude information is determined not to be correct, delivery-destination map information in which a position of the accepted address character string is displayed on a map, based on the extracted position information.

### CROSS-REFERENCE TO RELATED APPLICATIONS

This application claims the benefit of Japanese Patent Application No. 2024-030671, filed on Feb. 29, 2024, the entire disclosure of which is incorporated by reference herein.

### FIELD OF THE INVENTION

This application relates to a providing device, a providing method, and a non-transitory recording medium.

### BACKGROUND OF THE INVENTION

A technology for assisting a deliverer in efficiently delivering a package has been known. For example, in Patent Literature 1 (Unexamined Japanese Patent Application Publication No. 2021-160904), a delivery assistance system that generates, based on a delivery history, delivery time period information indicating a time period in which a probability that delivery to a delivery destination succeeds is highest, with respect to each of a plurality of delivery destinations and sets a delivery sequence that is a sequence of delivery to the plurality of delivery destinations is disclosed. The delivery assistance system generates delivery-destination map information in which a delivery destination is plotted on a map and causes a communication terminal device that a deliverer carries to display the delivery-destination map information.

### SUMMARY OF THE INVENTION

Meanwhile, in general, when a delivery destination is plotted on a map, an address of the delivery destination is converted to position information such as latitude and longitude by geocoding. However, there are some cases where a delivery destination is plotted at a wrong position on a map due to a reason that wrong position information is associated with an address or an area such as municipalities is indicated on a map by a polygon due to a reason that a point corresponding to the address cannot be identified. In such cases, there is a problem in that the delivery assistance system disclosed in Patent Literature 1 cannot provide a deliverer with a position of a delivery destination correctly.

The present disclosure has been made in consideration of the above-described circumstances, and an objective of the present disclosure is to provide a providing device, a providing method, and a non-transitory recording medium that are capable of providing a position of a delivery destination even when correct position information of the delivery destination cannot be acquired by geocoding.

In order to solve the above-described problem, a providing device according to the present disclosure includes one or more processors, and the processors accept an address character string of a delivery destination of a package, acquire latitude-longitude information associated with the accepted address character string, extract position information recorded in association with the accepted address character string from a database that associates an address character string representing a delivery destination a delivery of a package to which is completed with position information of a position where a deliverer who delivered a package to the delivery destination was present when the deliverer performed a predetermined action, determine, by comparing the acquired latitude-longitude information with the extracted position information, whether or not the latitude-longitude information is correct, and provide, when the latitude-longitude information is determined to be correct, delivery-destination map information in which a position determined based on the latitude-longitude information is displayed on a map and provide, when the latitude-longitude information is determined not to be correct, delivery-destination map information in which a position of the accepted address character string is displayed on a map, based on the extracted position information.

According to the present disclosure, a providing device, a providing method, and a non-transitory recording medium that are capable of providing a position of a delivery destination even when correct position information of the delivery destination cannot be acquired by geocoding.

### BRIEF DESCRIPTION OF DRAWINGS

A more complete understanding of this application can be obtained when the following detailed description is considered in conjunction with the following drawings, in which:

FIG. 1 is an explanatory diagram illustrating a connection between a providing device and other equipment;

FIG. 2 is an explanatory diagram illustrating a functional configuration of the providing device;

FIG. 3 is a diagram illustrating an example of delivery-destination map information provided by a provider;

FIG. 4 is a diagram illustrating another example of the delivery-destination map information provided by the provider;

FIG. 5 is a diagram illustrating an example of time series data acquired by a position information acquirer;

FIG. 6 is a diagram illustrating an example of time series data extracted by a partial time series extractor;

FIG. 7 is a diagram describing an example of partial time series divided by the partial time series extractor;

FIG. 8 is a diagram illustrating an example of association information generated by an association information generator;

FIG. 9 is an explanatory diagram illustrating a physical configuration of the providing device;

FIG. 10 is a flowchart of association information generation processing performed by the providing device;

FIG. 11 is a diagram illustrating an example of a delivery completion list;

FIG. 12 is a flowchart of providing processing performed by the providing device;

FIG. 13 is a flowchart of association information generation processing performed by a providing device according to a variation;

FIG. 14A is a diagram illustrating another example of the delivery-destination map information provided by the provider;

FIG. 14B is a diagram illustrating still another example of the delivery-destination map information provided by the provider; and

FIG. 15 is a diagram illustrating still another example of the delivery-destination map information provided by the provider.

### DETAILED DESCRIPTION OF THE INVENTION

A providing device, a providing method, and a non-transitory recording medium according to an embodiment for embodying the present disclosure are described below in detail with reference to the drawings. Note that the same or corresponding parts in the drawings are designated by the same reference numerals. Note that the embodiment to be described below is for explaining the present disclosure, not for limiting the scope of the present disclosure.

Accordingly, it is possible for a person skilled in the art to employ embodiments in which part or all of the elements of the embodiments are replaced by equivalents thereof, which are also included in the scope of the present disclosure.

A providing device according to the present embodiment determines whether or not latitude-longitude information of a delivery destination, the latitude-longitude information being acquired using a map search site or a geocoding service, is correct based on delivery records.

When the providing device determines that the acquired latitude-longitude information is not correct, the providing device provides a deliverer terminal with delivery-destination map information in which a position of the delivery destination is displayed on a map, based on position information of a deliverer when delivery to the delivery destination was performed in the past.

Although the providing device of the present embodiment is generally achieved by causing a computer to execute a program, it is also possible to cause a dedicated electronic circuit to execute processing. Alternatively, it is also possible to configure the providing device of the present embodiment by applying a technology, such as a field programmable gate array

(FPGA), in which a program is compiled into a design script of an electronic circuit and the electronic circuit is dynamically configured based on the design script, as an intermediate form between a computer and a dedicated electronic circuit.

The providing device according to the present embodiment is achieved by one or a plurality of server computers executing functions achieved by one or a plurality of server programs, the server computers communicating with a deliverer terminal.

The deliverer terminal according to the present embodiment is a terminal computer that achieves a smartphone, a tablet computer, a wearable terminal, or the like and can be achieved by executing a terminal program that is provided in advance. As the terminal program, a program equivalent to a so-called “app” can be employed.

Alternatively, as the terminal program, a general browser can be employed, and a script program that operates on a browser can also be employed as the terminal program.

In general, a program executed in a server computer or a terminal computer can be recorded in a non-transitory computer-readable information recording medium, such as a compact disc, a flexible disk, a hard disk, a magneto optical disk, a digital video disk, a magnetic tape, a read only memory (ROM), an electrically erasable programmable ROM (EEPROM), a flash memory, and a semiconductor memory. The non-transitory information recording medium can be distributed or sold independently of the server computer.

In the server computer and the terminal computer, after a program recorded in a non-transitory information recording medium, such as a flash memory and a hard disk, is retrieved into a random access memory (RAM), which is a temporary storage device, a central processing unit (CPU) executes commands included in the retrieved program. However, in an architecture in which a program can be executed by mapping the ROM and the RAM into one memory space, the CPU directly retrieves and executes commands included in a program stored in the ROM.

Further, the server program and the terminal program can be distributed or sold from a distribution server or the like that a provider manages to the server computer, the terminal computer, and the like via a temporary transmission medium, such as a computer communication network, independently of the computer in which the program is executed.

Note that when the providing device is configured by a plurality of computers, programs operating in the computers are a plurality of server programs that differ from one another and collaborate with one another while having different functions. Therefore, a program obtained by combining the plurality of programs can be considered as a system program for achieving the providing device.

### Overall Configuration

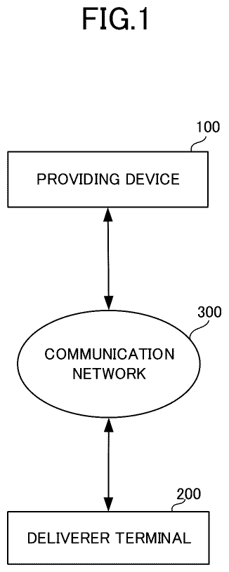

FIG. 1 is an explanatory diagram illustrating a connection between the providing device and other equipment. The following description is made with reference to the drawing.

A providing device 100 is connected to a deliverer terminal 200 via a communication network 300, such as the Internet. Note that although in FIG. 1, one deliverer terminal 200 is illustrated, a plurality of deliverer terminals 200 may be connected to the communication network 300.

The providing device 100 is a device that, for example, a provider providing home delivery service of packages or an online supermarket operates, and accepts an address character string indicating an address of a delivery destination to which a package is to be delivered and acquires latitude-longitude information corresponding to the address character string from a geocoding server (not illustrated) that performs geocoding. The providing device 100 extracts position information corresponding to the accepted address character string from a database (DB) that stores an address character string of a delivery destination where the delivery of a package is completed and position information of a deliverer when the deliverer who delivered a package to the delivery destination performs a predetermined action, in association with each other.

The providing device 100 determines whether or not the acquired latitude-longitude information is correct by comparing the latitude-longitude information acquired from the geocoding server with the position information extracted from the DB. When the providing device 100 determines that the acquired latitude-longitude information is correct, the providing device 100 causes the deliverer terminal 200 to display delivery-destination map information in which a position indicated by the acquired latitude-longitude information is displayed on a map. In contrast, when the providing device 100 determines that the acquired latitude-longitude information is not correct, the providing device 100 causes the deliverer terminal 200 to display delivery-destination map information in which a position of the delivery destination is displayed on a map, based on the position information extracted from the DB.

The deliverer terminal 200 is a delivery-dedicated terminal, such as a smartphone and a tablet, that a deliverer who delivers a package carries while engaging in work and is a terminal that accepts input of a delivery status or other operation data and that displays map information representing a delivery schedule, a position of a delivery destination, a route to the delivery destination, and the like. The deliverer terminal 200 includes a position detector to detect a position of the deliverer terminal 200 and a display to display information.

The position detector includes a receiver to receive a signal from a satellite. The receiver is, for example, a global positioning system (GPS) that is a system to measure a current position.

The position detector acquires a latitude and a longitude that are position information of the deliverer terminal 200, based on a signal that is received by the GPS every preset time. The deliverer terminal 200 transmits the position information acquired by the position detector and a time when the position information is acquired in association with each other to the providing device 100. The providing device 100 generates time series data, based on the received position information and time and extracts a partial time series corresponding to a time section in which the deliverer is estimated to have performed a predetermined action, from the generated time series data. The providing device 100 causes the DB to store position information included in the extracted partial time series and an address character string of a delivery destination in association with each other. Note that the position detector may acquire the position information of the deliverer terminal 200, based on mobile telephone base stations that are communicating with the deliverer terminal 200. Alternatively, the position detector may acquire the position information of the deliverer terminal 200, based on wireless LAN base stations that are communicating with the deliverer terminal 200.

The display is, for example, a liquid crystal display, an organic EL display, or the like. For example, the deliverer inputs an address character string of a delivery destination to which the deliverer is to deliver a package, causes the display to display delivery-destination map information in which the position of the delivery destination is displayed on a map, confirms the position of the delivery destination and a route from the current position to the delivery destination, and performs delivery operation of the package.

The communication network 300 can include various types of networks. For example, the communication network 300 can include a local area network (LAN), a wide area network (WAN) such as the Internet, a telecommunication network such as a public switched telephone network (PSTN), a wireless network, a public switched network, a satellite network, a cellular network, a public land mobile network (PLMN), a metropolitan area network (MAN), a private network, an ad hoc network, an intranet, an optical fiber-based network, or a combination of the foregoing or other types of networks.

### Functional Configuration of Providing Device

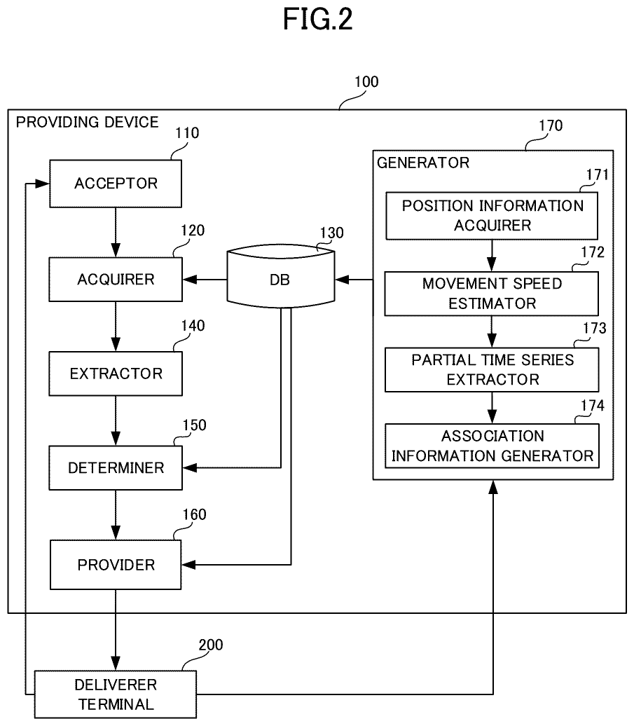

Next, a functional configuration of the providing device 100 is described, using FIG. 2. The providing device 100 includes an accepter 110, an acquirer 120, a database (DB) 130, an extractor 140, a determiner 150, a provider 160, and a generator 170.

The accepter 110 accepts an address character string that is a character string representing an address of a delivery destination. Specifically, a deliverer inputs an address character string of a delivery destination that the deliverer is to visit next by, for example, operating an input device of a deliverer terminal 200. The deliverer terminal 200 transmits the input address character string to the providing device 100. The accepter 110 receives the address character string input by the deliverer.

The acquirer 120 acquires latitude-longitude information including a latitude and a longitude corresponding to the address character string received by the accepter 110.

Specifically, the acquirer 120 transmits the address character string to the geocoding server that converts an address character string to latitude-longitude information and receives latitude-longitude information corresponding to the transmitted address character string from the geocoding server.

The DB 130 stores association information that associates an address character string of a delivery destination where the delivery of a package is completed and position information of positions where a deliverer is present when the deliverer who delivers a package to the delivery destination performs a predetermined action. The predetermined action means, for example, an action taken with respect to each delivery destination from when the deliverer stops a vehicle at a parking or stopping position and gets off the vehicle until the deliverer delivers a package, returns to the parking or stopping position, and gets on the vehicle. The association information is generated by the generator 170 and stored in the DB 130.

The extractor 140 extracts position information associated with an address character string received by the accepter 110. Specifically, the extractor 140 extracts position information associated with the accepted address character string with reference to the association information stored in the DB 130.

The determiner 150 determines whether or not latitude-longitude information acquired by the acquirer 120 is correct. Specifically, the determiner 150 determines whether or not the latitude-longitude information acquired by the acquirer 120 is an outlier with respect to a distribution of position information extracted by the extractor 140. When the determiner 150 determines that the latitude-longitude information is an outlier, the determiner 150 determines that the latitude-longitude information is not correct, and when the determiner 150 determines that the latitude-longitude information is not an outlier, the determiner 150 determines that the latitude-longitude information is correct. Details of the processing performed by the determiner 150 are described later.

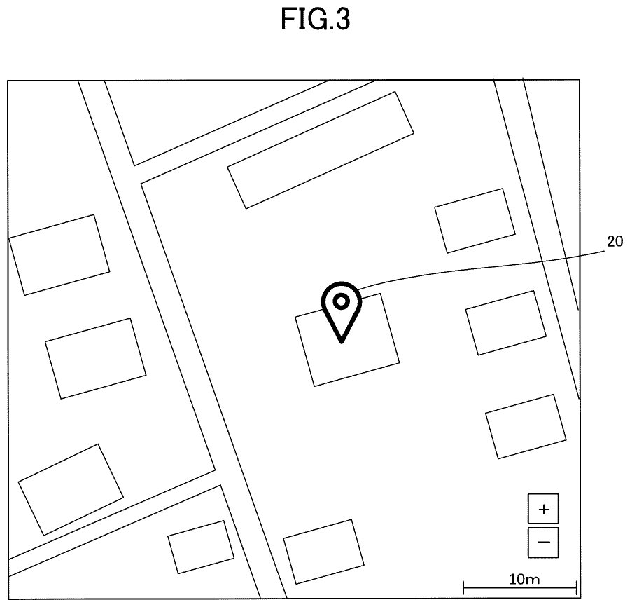

The provider 160 causes the deliverer terminal 200 to display delivery-destination map information in which the position of the delivery destination is displayed on a map. Specifically, when the latitude-longitude information acquired by the acquirer 120 is determined to be correct by the determiner 150, the provider 160 causes the deliverer terminal 200 to display delivery-destination map information in which a position indicated by the latitude-longitude information acquired by the acquirer 120 is displayed on a map as the position of the delivery destination. An example of the delivery-destination map information provided by the provider 160 when the latitude-longitude information acquired by the acquirer 120 is determined to be correct is illustrated in FIG. 3. As illustrated in the drawing, the delivery-destination map information is a surrounding map of a position indicated by the latitude-longitude information acquired by the acquirer 120, and at the position, a position icon 20 indicating the position of the delivery destination is arranged.

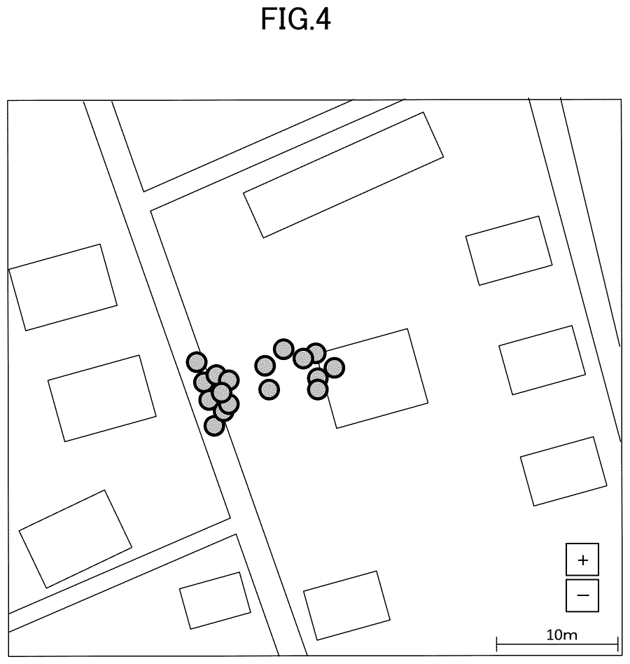

In addition, when the latitude-longitude information acquired by the acquirer 120 is determined not to be correct by the determiner 150, the provider 160 causes the deliverer terminal 200 to display delivery-destination map information in which the position of the delivery destination is displayed on a map, based on the position information extracted by the extractor 140. An example of the delivery-destination map information provided by the provider 160 when the latitude-longitude information acquired by the acquirer 120 is determined not to be correct is illustrated in FIG. 4. As illustrated in the drawing, the delivery-destination map information is map information that is provided with a distribution of position information, which is extracted by the extractor 140, superimposed on a map and is displayed with a plurality of pieces of position information, which is extracted by the extractor 140, plotted on the map. Returning to FIG. 2, the generator 170 includes a position information acquirer 171, a movement speed estimator 172, a partial time series extractor 173, and an association information generator 174 and generates association information to be stored in the DB 130. Specifically, the generator 170 acquires position information from the deliverer terminal 200, extracts, with respect to each delivery destination, position information from when the deliverer stops a vehicle at a parking or stopping position and gets off the vehicle until the deliverer delivers a package and gets on the vehicle, and associates the position information with the address character string of the delivery destination. The generator 170 generates time series data in which positions of the deliverer terminal 200 are arranged in a chronological order and calculates a movement speed at each position. The generator 170 extracts, based on the movement speeds, a partial time series corresponding to a time section during which the deliverer is estimated not to be on board a vehicle and generates association information by associating the extracted partial time series with the address character string of the delivery destination.

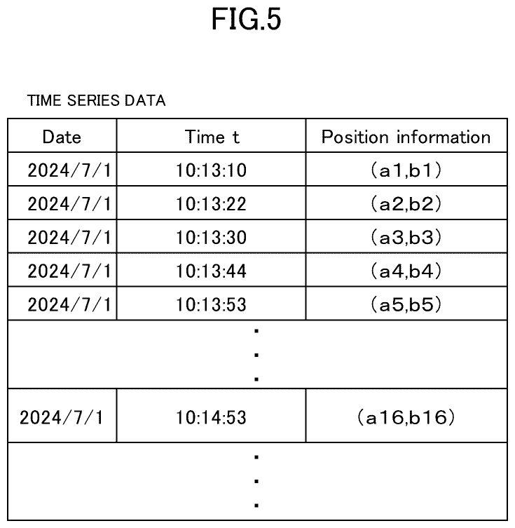

The position information acquirer 171 receives position information of the deliverer terminal 200 and acquisition times of the position information from the deliverer terminal 200 and generates time series data. The time series data are stored in a memory of the providing device 100. An example of the time series data is illustrated in FIG. 5. As illustrated in the drawing, the time series data include a “date” indicating a date on which the deliverer terminal 200 acquired position information, a “time t” indicating an acquisition time, a “position information” indicating acquired position coordinates, and the like. Note that the time series data may include information about a terminal ID or the like identifying a deliverer terminal 200 having collected the position information.

Returning to FIG. 2, the movement speed estimator 172 estimates movement speed of the deliverer terminal 200. Specifically, the movement speed estimator 172 calculates movement distance and movement time of the deliverer terminal 200 from time information and position information included in the time series data, such as one illustrated in FIG. 5, that are accumulated in the memory of the providing device 100. The movement speed estimator 172 calculates movement speed of the deliverer terminal 200 from the calculated movement distance and movement time.

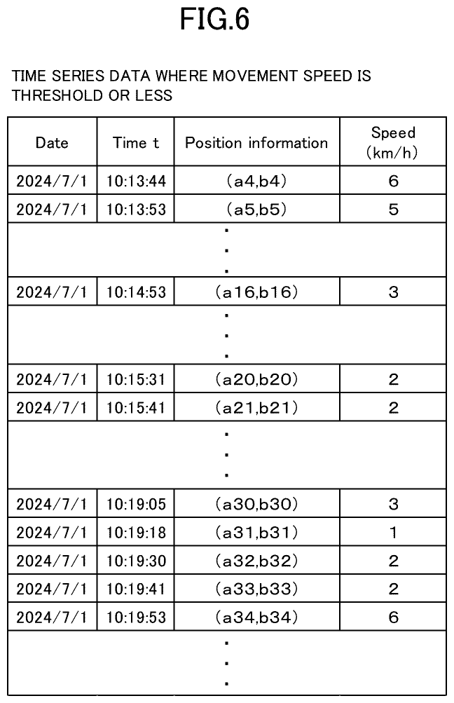

The partial time series extractor 173 extracts, with respect to each delivery destination, a partial time series that is time series data in a time section during which the deliverer is estimated not to be on board a vehicle from the time series data accumulated in the memory of the providing device 100. Specifically, the partial time series extractor 173 extracts a partial time series with respect to each delivery destination, based on a preset rule. For example, as illustrated as an example in FIG. 6, the partial time series extractor 173 extracts data where movement speed calculated by the movement speed estimator 172 is less than or equal to a preset threshold value such as 6 km/h, from time series data, illustrated in FIG. 5, that are acquired by the position information acquirer 171. Note that the threshold value relating to the movement speed is not limited to 6 km/h and may be set to an arbitrary speed by which a deliverer is estimated not to be moving by a vehicle.

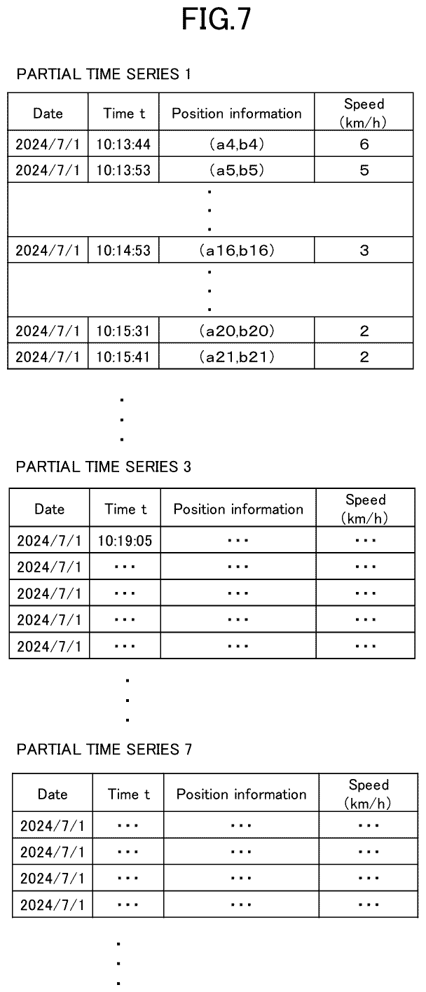

Next, the partial time series extractor 173 divides time series data where movement speed is less than or equal to the threshold value into a plurality of temporally continuous partial time series. Specifically, in time series data when packages are delivered to a plurality of delivery destinations, at least a plurality of partial time series in each of which the deliverer is estimated not to be on board the vehicle with respect to one of the delivery destinations is included. The partial time series extractor 173 divides the extracted time series data into a plurality of partial time series, as illustrated as an example in FIG. 7, in accordance with an arbitrary rule such as, when a difference in times between a piece of time series data and the previous piece of time series data is within 1 minute, classifying the two pieces of time series data into the same partial time series and, when a difference in times between the piece of time series data and the previous piece of time series data is greater than or equal to 1 minute, classifying the two pieces of time series into different partial time series.

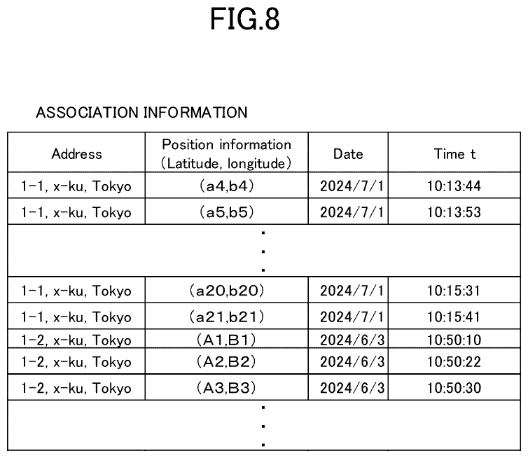

Returning to FIG. 2, the association information generator 174 generates association information by associating each of the partial time series into which the extracted time series data are divided by the partial time series extractor 173 with an address character string of a delivery destination. Specifically, the association information generator 174 generates, with reference to delivery completion list that records a delivery completion time indicating a time when delivery of a package to each delivery destination is completed, association information by associating a partial time series including a piece of time series data having a time closest to a delivery completion time of delivery to each delivery destination with an address character string of the delivery destination. An example of the association information generated by the generator 170 is illustrated in FIG. 8. As illustrated in the drawing, the association information includes information such as an “address” indicating an address character string of a delivery destination the delivery to which is completed, “position information” indicating position information of the deliverer terminal 200, a “date” indicating a date when the position information is acquired, and an “acquisition time” indicating an acquisition time of the position information. The illustrated example indicates that a plurality of pieces of position information (a4, b4), (a5, b5), . . . , (a20, b20), and (a21, b21) and dates and times when the position information is acquired are associated with an address “1-1, X-ku, Tokyo”. The association information generator 174 transmits the generated association information to the DB 130 and causes the DB 130 to store the association information.

### Hardware Configuration of Information Processing Device

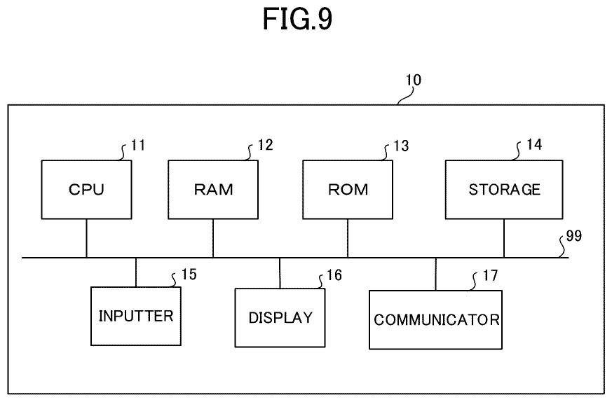

FIG. 9 is a block diagram illustrating a hardware configuration of an information processing device 10 by which the providing device 100 and the deliverer terminal 200 are achieved. The information processing device 10 includes a CPU 11 to execute processing in accordance with a program, a RAM 12 that is a volatile memory, a ROM 13 that is a non-volatile memory, a storage 14 to store data, an inputter 15 to accept input of information, a display 16 to visualize and display information, and a communicator 17 to perform transmission and reception of information, and such constituent components are connected to one another via an internal bus 99.

The CPU 11 controls operation of the entire information processing device 10, is connected to the constituent components, and communicates a control signal and data with the constituent components. The CPU 11 executes various types of processing by retrieving a program stored in the storage 14 into the RAM 12 and executing the program. The CPU 11 executes, as major functions provided by the program, pieces of processing performed by the accepter 110, the acquirer 120, the extractor 140, the determiner 150, the provider 160, and the generator 170.

The RAM 12 is a memory for temporarily recording data and programs, and programs and data retrieved from the storage 14, data required for communication, and the like are retained in the RAM 12. The RAM 12 is used as a work area for the CPU 11.

The ROM 13 stores a control program, a basic input output system (BIOS), and the like that the CPU 11 executes for basic operation of the information processing device 10.

The storage 14 includes a hard disk drive, a flash memory, and the like, stores programs that the CPU 11 executes, and stores various types of data used at the time of execution of the programs. The storage 14 functions as the DB 130.

The inputter 15 is a user interface including a touch panel, a keyboard, a mouse, a communication device, and the like. The inputter 15 accepts operation input from a user of the information processing device 10 and outputs a signal corresponding to the accepted operation input to the CPU 11.

The display 16 is a display device, such as a liquid crystal display and an organic electro luminescence (EL) display, that visualizes and displays information.

The communicator 17 is a network terminal device or a radio communication device connected to a network and a serial interface or a local area network (LAN) interface connected to the network terminal device or the radio communication device. The information processing device 10 communicates with another information processing device or the like via the communicator 17. The communicator 17 functions as the accepter 110 and the acquirer 120.

### Association Information Generation Processing

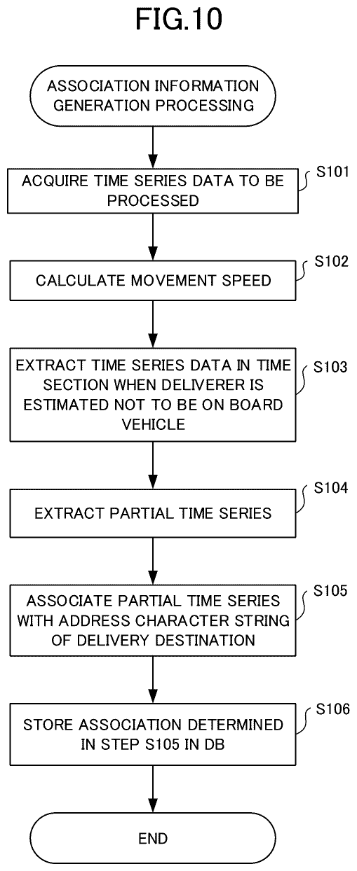

Next, operation of the providing device 100 is described. First, processing of, with respect to each delivery destination, extracting time series data from when a deliverer stops a vehicle at a parking or stopping position and gets off the vehicle until the deliverer delivers a package and gets on the vehicle and generating association information associating the extracted time series data with an address character string of the delivery destination, based on delivery records is described with reference to FIG. 10.

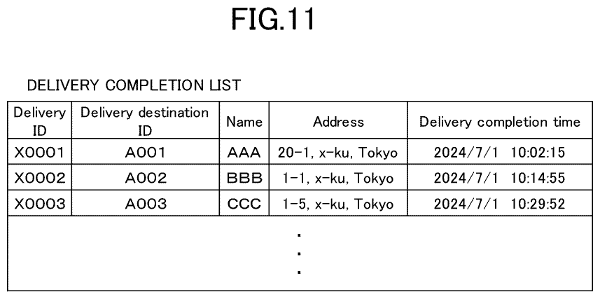

As advance preparation, in the storage 14 of the providing device 100, time series data such as one illustrated in FIG. 5 and a delivery completion list such as one illustrated in FIG. 11 are stored in advance.

The position information acquirer 171 of the providing device 100 receives pieces of position information and times when the pieces of position information are acquired that are transmitted from the deliverer terminal 200, generates time series data such as one illustrated in FIG. 5, and causes the storage 14 to store the time series data.

When delivery of a package is completed, the deliverer inputs delivery completion information including delivery identification information and transmits the delivery completion information from the deliverer terminal 200 to the providing device 100. The providing device 100 includes the transmitted delivery completion information in a database in conjunction with a delivery completion time and stores the database in the storage 14. An example of a delivery completion list obtained by including delivery completion information in a database is illustrated in FIG. 11. As illustrated in the drawing, the delivery completion list includes information such as a “delivery ID” for uniquely identifying delivery information, a “delivery destination ID” that is identification information identifying a delivery destination, a “name” indicating a name of a delivery destination, an “address” indicating an address character string of a delivery destination, and a “delivery completion time” indicating a delivery completion time for each delivery destination. Note that in the delivery completion time field, a time when delivery completion is reported by the deliverer performing an operation such as pressing a delivery completion button displayed on a screen of the deliverer terminal 200 or a time input by the deliverer may be stored.

Returning to FIG. 10, when an admin user of the providing device 100 sets a period during which data to be processed are to be acquired and instructs the providing device 100 to start association information generation processing by operating the inputter 15 of the providing device 100, the providing device 100 starts the processing.

The movement speed estimator 172 acquires time series data to be processed (step S101). Specifically, the movement speed estimator 172 acquires time series data during the set period from the storage 14 of the providing device 100.

Next, the movement speed estimator 172 estimates movement speed of the deliverer terminal 200 (step S102). Specifically, the movement speed estimator 172 calculates movement distance and movement time of the deliverer terminal 200 from time information and position information included in the time series data, illustrated in FIG. 5, that are acquired in step S101 and calculates a movement speed of the deliverer terminal 200 from the calculated movement distance and movement time. For example, when a movement speed at the position information (a2, b2) in the example is to be calculated, the movement speed estimator 172 calculates a movement distance that is a distance between the position information (a1, b1) of the previous piece of time series data and (a2, b2) and a movement time that is a difference between an acquisition time t2 of 10:13:22 of the position information (a2, b2) and an acquisition time t1 of 10:13:10 of the position information (a1, b1) and calculates the movement speed by dividing the movement distance by the movement time. In addition, for example, the movement speed estimator 172 may calculate, using the previous and next pieces of time series data, a movement distance that is a sum of a distance between the position information (a1, b1) of the previous piece of time series data and (a2, b2) and a distance between the position information (a3, b3) of the next piece of time series data and (a2, b2) and a movement time that is a difference between an acquisition time t3 of 10:13:30 of the position information (a3, b3) and an acquisition time t1 of 10:13:10 of the position information (a1, b1) and calculate the movement speed at the position information (a2, b2) using a method such as dividing the movement distance by the movement time.

Returning to FIG. 10, next, the partial time series extractor 173 extracts, based on the movement speeds calculated in step S102, time series data in time sections during each of which the deliverer is estimated not to be on board the vehicle, from the time series (step S103).

Specifically, as illustrated in FIG. 6, the partial time series extractor 173 extracts data where the movement speed calculated by the movement speed estimator 172 is less than or equal to 6 km/h, which is a preset threshold value, from the time series data.

Returning to FIG. 10, next, the partial time series extractor 173 divides the time series data where the movement speed is less than or equal to the threshold value into data in a plurality of temporally continuous time sections and thereby extracts partial time series (step S104). The partial time series extractor 173 divides the time series data where the movement speed is less than or equal to the threshold value into a plurality of partial time series, in accordance with an arbitrary rule such as, when a difference in times between a piece of time series data and the previous piece of time series data is within 1 minute, classifying the two pieces of time series data into the same partial time series and, when a difference in times between a piece of time series data and the previous piece of time series data is greater than or equal to 1 minute, classifying the two pieces of time series data into different time series, as illustrated in FIG. 7.

Next, the association information generator 174 determines, based on a delivery completion list such as one illustrated in FIG. 11, an association of each of the divided partial time series with an address character string of a delivery destination (step S105). Specifically, the association information generator 174 extracts a delivery history on the same date as the acquisition date of the partial time series from the delivery completion list. The association information generator 174 identifies a partial time series including a piece of time series data that is closest to the delivery completion time of the extracted delivery history from among the partial time series extracted in step S104 and associates the identified partial time series with the address character string of the delivery destination. For example, in the case of “1-1, X-ku, Tokyo” in the delivery completion list, the association information generator 174 identifies a piece of time series data having a time “10:14:53” that is closest to the delivery completion time “10:14:55” of the delivery destination, from the partial time series illustrated in FIG. 7, and determines to associate a partial time series 1 including the piece of time series data with the delivery destination. Note that the association information generator 174 may calculate an average of times of pieces of time series data included in each partial time series and determine to associate a partial time series having a calculated average closest to the delivery completion time with the delivery destination.

Returning to FIG. 10, next, the association information generator 174 causes the DB 130 to store the associations determined in step S105 (step S106). Specifically, the association information generator 174 transmits an address character string and position information, dates, and times included in an associated partial time series to the DB 130. The DB 130 generates association information such as one illustrated in FIG. 8 by adding information relating to received associations and stores the generated association information.

### Providing Processing

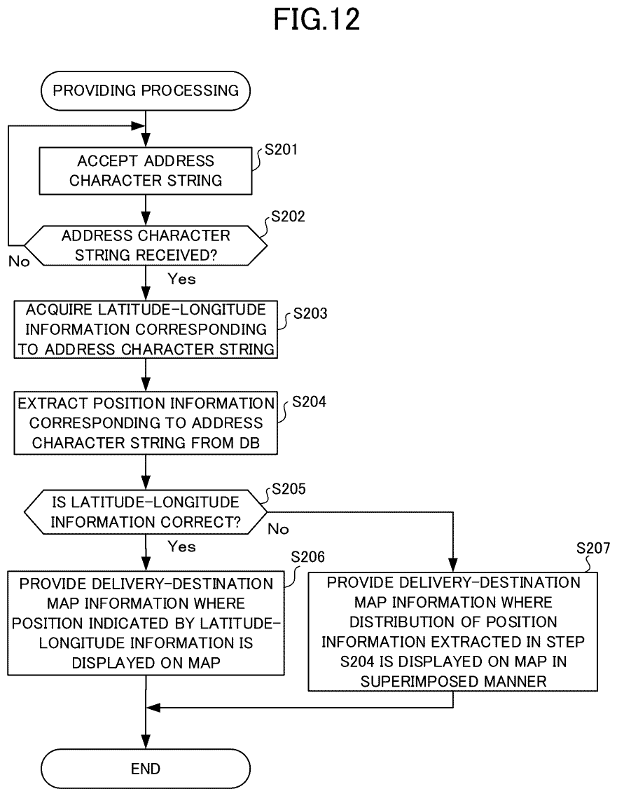

Next, providing processing of generating delivery-destination map information in which the position of a delivery destination represented by an address character string is displayed on a map and providing the deliverer with the generated delivery-destination map information is described with reference to FIG. 12.

The accepter 110 accepts an address character string (step S201). Specifically, a deliverer confirms a delivery schedule and inputs an address character string of a next delivery destination by operating the inputter 15 of the deliverer terminal 200. The deliverer terminal 200 transmits the input address character string to the providing device 100.

When the accepter 110 determines that the accepter 110 has received an address character string (step S202; Yes), the accepter 110 transmits the received address character string to the acquirer 120 and transitions to step S203. In contrast, when the accepter 110 determines that the accepter 110 has not received an address character string (step S202; No), the accepter 110 returns to step S201 and accepts input of an address character string.

Next, the acquirer 120 acquires latitude-longitude information corresponding to the address character string (step S203). Specifically, the acquirer 120 transmits the address character string received in step S202 to the geocoding server and receives latitude-longitude information corresponding to the transmitted address character string from the geocoding server.

Next, the extractor 140 extracts position information associated with the address character string from the DB 130 (step S204). Specifically, the extractor 140 extracts position information corresponding to the address character string received in step S202 with reference to the association information illustrated in FIG. 8. For example, when the address character string “1-1, X-ku, Tokyo” is accepted, the extractor 140 extracts pieces of position information (a4, b4), (a5, b5), . . . , (a21, b21) corresponding to “1-1, X-ku, Tokyo”.

Returning to FIG. 12, next, the determiner 150 determines whether or not the latitude-longitude information acquired in step S203 is correct (step S205). Specifically, the determiner 150 determines whether or not the latitude-longitude information acquired by the acquirer 120 is an outlier with respect to a distribution of position information extracted by the extractor 140. The determiner 150, for example, calculates a centroid of the pieces of position information (a4, b4), (a5, b5), . . . , (a21, b21) extracted in step S204 and determines, when distance between the calculated centroid and the latitude-longitude information acquired by the acquirer 120 is greater than a predetermined threshold value, that the latitude-longitude information is an outlier and that the latitude-longitude information is not correct (step S205; No). In contrast, when the distance between the calculated centroid and the latitude-longitude information is less than or equal to the predetermined threshold value, the determiner 150 determines that the latitude-longitude information is not an outlier and that the latitude-longitude information is correct (step S205; Yes).

In addition, when the latitude-longitude information acquired in step S203 is not information defining a point but area information defining a geographical area such as municipalities, the determiner 150 determines that the acquired latitude-longitude information is not correct (step S205; No). Note that when in step S203, error information is received due to non-existence of latitude-longitude information corresponding to the address character string, the determiner 150 may determine that the latitude-longitude information acquired in step S203 is not correct.

When the latitude-longitude information is determined to be correct by the determiner 150 (step S205; Yes), the provider 160 provides the deliverer terminal 200 with delivery-destination map information in which a position indicated by the latitude-longitude information acquired by the acquirer 120 is displayed on a map (step S206). Specifically, the provider 160 generates delivery-destination map information in which the position icon 20 is arranged on a surrounding map of a position indicated by the latitude-longitude information acquired by the acquirer 120, as illustrated as an example in FIG. 3, causes the deliverer terminal 200 to display the delivery-destination map information, and terminates the providing processing.

In contrast, when the latitude-longitude information is determined not to be correct by the determiner 150 (step S205; No), the provider 160 provides the deliverer terminal 200 with delivery-destination map information in which the position of the delivery destination is displayed on a map, based on the position information extracted by the extractor 140 (step S207). Specifically, the provider 160 generates delivery-destination map information in which, by plotting a distribution of the pieces of position information (a4, b4), (a5, b5), . . . , (a21, b21) extracted by the extractor 140 on the surrounding map, the distribution is superimposed on the surrounding map, as illustrated as an example in FIG. 4, causes the deliverer terminal 200 to display the delivery-destination map information, and terminates the providing processing.

Note that when in step S204, due to non-existence of a delivery record to the delivery destination represented by the address character string received in step S202, position information corresponding to the address character string cannot be extracted, position information corresponding to an address character string similar to the address character string may be extracted. Specifically, the extractor 140 is only required to, for example, acquire, in a comparison between the address character string received in step S202 and another address character string stored in the association information, a common character string by scanning both address character strings from a wide area toward a narrow area, calculates a degree of similarity between both address character strings, using a formula such as 2×c/(a+b) and c×2/(a×b) where a denotes the number of characters in the address character string received in step S202, b denotes the number of characters in the another address character string, and c denotes the number of characters in the common character string, and extract position information of an address character string having a largest degree of similarity from the association information. Subsequently, the processing in steps S205 to S207 is only required to be executed, using the position information of the extracted similar address character string. Note that in this case, the threshold value relating to distance that is used when whether or not the latitude-longitude information acquired in step S203 is correct is determined in step S205 may be set to a threshold value different from the threshold value used in the case where position information corresponding to the address character string received in step S202 can be extracted. In addition, since the delivery-destination map information provided in the processing in step S207 is map information that indicates a position of a delivery destination similar to the address character string received in step S202, the deliverer terminal 200 may be caused to display a message to that effect.

As described in the foregoing, the providing device 100 extracts position information when the deliverer performs a predetermined action from time series data on positions of the deliverer terminal 200 that are detected in a delivery process, associates the extracted position information with the address character string of a delivery destination, and accumulates the association in the DB 130. When an address character string of a delivery destination to which a package is to be delivered is input, the providing device 100 determines whether or not the latitude-longitude information of the delivery destination acquired from the geocoding service is correct with reference to the DB 130. When the providing device 100 determines that the latitude-longitude information is not correct, the providing device 100 extracts position information associated with the address character string from the DB 130, generates delivery-destination map information in which a distribution of the extracted position information is superimposed on a surrounding map, and causes the deliverer terminal 200 to display the delivery-destination map information. Therefore, it becomes possible to provide the position of a delivery destination even when correct position information of the delivery destination cannot be acquired by geocoding.

### Variations

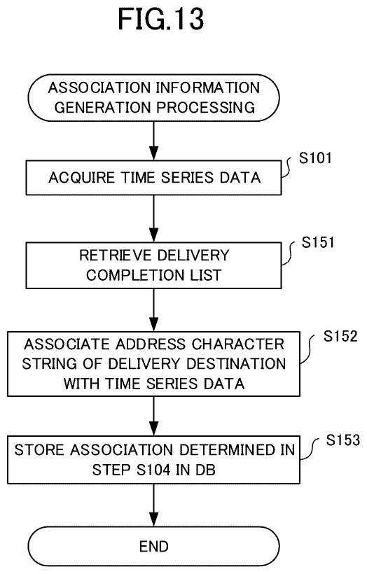

Although in the above-described embodiment, the description is made assuming that the association information stored in the DB 130 is information that associates position information in time series data from when the deliverer stops a vehicle at a parking or stopping position and gets off the vehicle until the deliverer delivers a package and gets on the vehicle with the address character string of a delivery destination and when the providing device 100 determines that the latitude-longitude information is not correct in step S205, the providing device 100 provides delivery-destination map information, based on the position information, the present disclosure is not limited to the configuration. For example, the association information may be information that associates position information of the deliverer when the deliverer completes a delivery of a package with the address character string of the delivery destination. Details of processing in this case are described with reference to FIG. 13. Note that since the processing in this case includes steps common to the flowchart illustrated in FIG. 10, the description is made focusing on differences.

When the same processing as the processing in step S101 in FIG. 10 is executed, the movement speed estimator 172 acquires time series data during a set period from the storage 14.

Next, the association information generator 174 retrieves a completion report list such as one illustrated in FIG. 11 (step S151) and extracts a record including a delivery destination the delivery to which is completed within the set period.

Next, the association information generator 174 identifies a piece of time series data having a time closest to a delivery completion time of the extracted record in the completion report list and associates the identified piece of time series data with an address character string of the record (step S152). Specifically, for example, in the example of the address “1-1, X-ku, Tokyo” in the completion report list illustrated in FIG. 11, the association information generator 174 identifies a piece of time series data having a time “10:14:53” that is closest to a delivery completion time “2024 Jul. 1 10:14:55” from the time series data illustrated in FIG. 5, and determines to associate position information (a16, b16) of the piece of time series data with the address character string “1-1, X-ku, Tokyo”.

Next, the association information generator 174 causes the DB 130 to store the association determined in step S152 in the same manner as in step S105 (step S153).

When the providing device 100 receives the address character string “1-1, X-ku, Tokyo” in step S202 in the providing processing illustrated in FIG. 12, the providing device 100 extracts the position information (a16, b16) corresponding to the address character string associated in step S152, in step S204.

Next, when distance between the position information (a16, b16) and the latitude-longitude information acquired in step S203 is greater than a predetermined threshold value, the providing device 100 is only required to determine that the latitude-longitude information is an outlier and that the latitude-longitude information is not correct (step S205; No) and provide delivery-destination map information in which the position icon 20 is displayed in a superimposed manner at a position represented by the position information (a16, b16) on a map (step S207).

In contrast, when the distance between the position information (a16, b16) and the latitude-longitude information acquired in step S203 is less than or equal to the predetermined threshold value, the providing device 100 is only required to determine that the latitude-longitude information is not an outlier and that the latitude-longitude information is correct (step S205; Yes) and provide delivery-destination map information in which a position indicated by the latitude-longitude information acquired in step S203 is displayed on a map (step S206).

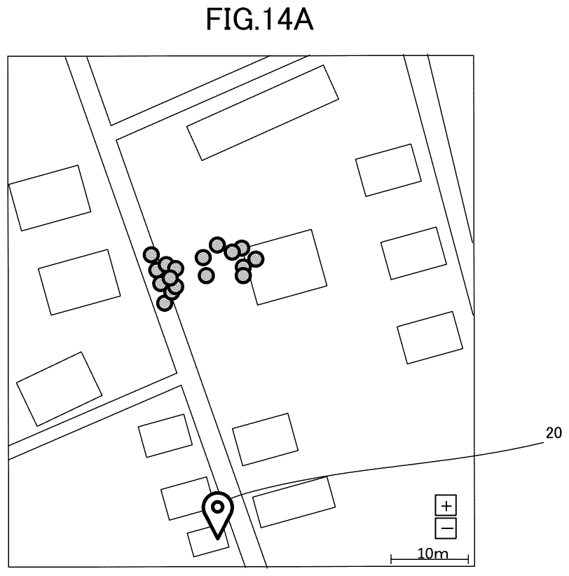

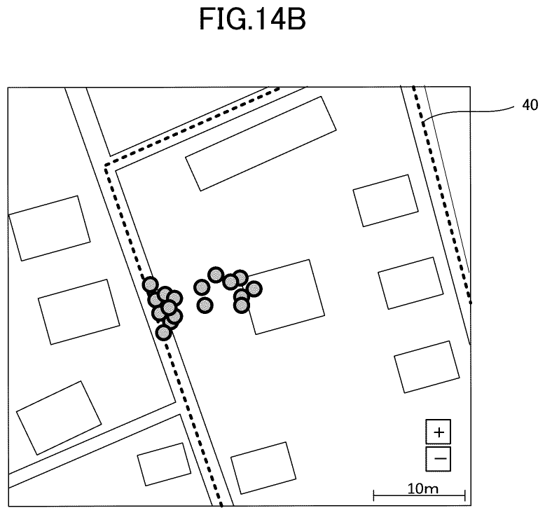

In addition, although in the above-described embodiment, the description is made assuming that when the latitude-longitude information acquired by the acquirer 120 is determined not to be correct by the determiner 150, the provider 160 provides delivery-destination map information in which a plurality of pieces of position information extracted by the extractor 140 is plotted on a map, as illustrated in FIG. 4, the present disclosure is not limited to the configuration. For example, the delivery-destination map information may be a heat map in which a mesh element in which density of points indicated by extracted pieces of position information is large is displayed in a thick color or map information in which the position icon 20 indicating the position of the delivery destination is plotted at the centroid of the plurality of pieces of extracted position information. In addition, as illustrated as an example in FIG. 14A, the provider 160 may provide delivery-destination map information in which the position icon 20 is arranged at a position indicated by the latitude-longitude information that is determined not to be correct and further, the plurality of pieces of position information extracted by the extractor 140 is plotted on a map. In addition, when the latitude-longitude information acquired by the acquirer 120 is area information indicating a geographical area, the provider 160 may provide delivery-destination map information in which a polygon 40 indicated by the area information is displayed on a map and further, the plurality of pieces of position information extracted by the extractor 140 is plotted on the map, as illustrated as an example in FIG. 14B.

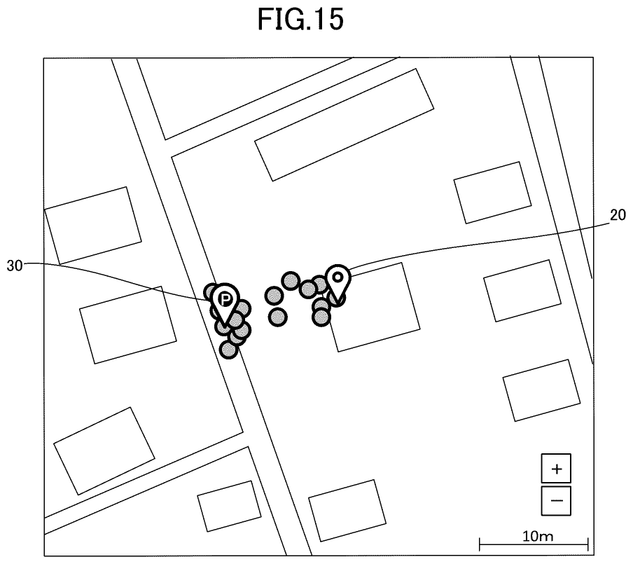

In addition, the provider 160 may provide delivery-destination map information such as one illustrated in FIG. 15 by identifying a parking or stopping position of the delivery destination and the position of the delivery destination, based on the association information illustrated in FIG. 8 and plotting the identified positions on the map. Specifically, the provider 160 extracts, from the association information, a predetermined number of head pieces of position information that are position information having an early acquisition time and a predetermined number of end pieces of position information that are position information having a late acquisition time. The provider 160 identifies a center position of the extracted pieces of position information as a parking or stopping position and identifies a piece of position information farthest from the identified parking or stopping position as the position of the delivery destination. For example, in the case of the address “1-1, X-ku, Tokyo”, the provider 160 extracts head pieces (a4, b4) and (a5, b5) and end pieces (a20, b20) and (a21, b21) of the position information, calculates a center position of (a4, b4), (a5, b5), (a20, b20), and (a21, b21), and arranges a parking or stopping position icon 30 at a position on a map indicated by the calculated center position. In addition, the provider 160 is only required to extract, from the association information, position information located farthest from the calculated center position and arrange the position icon 20 at a position indicated by the extracted position information on the map.

In addition, the providing device 100 may include a warner that, when the providing device 100 has not received delivery completion information from the deliverer terminal 200, causes the deliverer terminal 200 to display a warning message. For example, when the providing device 100 has not received delivery completion information from the deliverer terminal 200 for a set period, such as 30 minutes and 1 hour, the warner may cause the deliverer terminal 200 to display a warning message. In addition, the warner may cause the deliverer terminal 200 to display a warning message when, based on a delivery destination and a scheduled delivery time set in a delivery schedule in advance, the providing device 100 has not received delivery completion information of the delivery destination for a predetermined period since the scheduled delivery time.

In addition, the extractor 140 may, after extracting pieces of position information associated with the address character string in step S104, remove an outlier from the extracted pieces of position information and transmit a distribution after removal of the outlier to the determiner 150. For example, the extractor 140 may remove a piece of position information the distance of which from other extracted pieces of position information is greater than or equal to a predetermined threshold value, as an outlier.

In addition, although in the above-described embodiment, the description is made assuming that the provider 160 causes the deliverer terminal 200 to display delivery-destination map information, the present disclosure is not limited to the configuration. For example, when an address character string is transmitted by a delivery planning device that makes a delivery plan, delivery-destination map information may be provided to the delivery planning device.

In addition, it may be configured such that information that the providing device 100 stores is collectively managed by a cloud server existing on the network and the providing device 100 accesses the cloud server and reads and writes information from and to the cloud server. In this case, the providing device 100 does not have to include the DB 130. In addition, the association information generation processing and the providing processing performed by the providing device 100 may be executed on the cloud, using information stored in the cloud server.

Hereinafter, various modes of embodiment of the present disclosure are collectively described as Appendices.

### (Appendix 1)

A providing device, comprising one or more processors,
wherein the processors
accept an address character string of a delivery destination of a package,
acquire latitude-longitude information associated with the accepted address character string,
extract position information recorded in association with the accepted address character string from a database that associates an address character string representing a delivery destination a delivery of a package to which is completed with position information of a position where a deliverer who delivered a package to the delivery destination was present when the deliverer performed a predetermined action,
determine, by comparing the acquired latitude-longitude information with the extracted position information, whether or not the latitude-longitude information is correct, and
provide, when the latitude-longitude information is determined to be correct, delivery-destination map information in which a position determined based on the latitude-longitude information is displayed on a map and provide, when the latitude-longitude information is determined not to be correct, delivery-destination map information in which a position of the accepted address character string is displayed on a map, based on the extracted position information.

### (Appendix 2)

The providing device according to appendix 1, wherein
the predetermined action is an action from when the deliverer gets off a vehicle until the deliverer delivers a package to the delivery destination and gets on the vehicle, and
the processors
acquire a time series of positions of the deliverer, the positions being detected in a process in which the deliverer delivers a package,
estimate, from a time when each of the positions included in the acquired time series is detected, movement speed of the deliverer at each of the positions,
extract, based on the estimated movement speed, a partial time series, the partial time series indicating a time section during which the deliverer is estimated not to be on board a vehicle, from the acquired time series, and
generate association information that associates the extracted partial time series with an address character string of the delivery destination to which the deliverer delivered a package and store the generated association information in the database.

### (Appendix 3)

The providing device according to appendix 1 or 2, wherein the processors
determine whether or not the acquired latitude-longitude information is an outlier with respect to a distribution of the extracted position information, and determine, when determining that the latitude-longitude information is not an outlier, that the latitude-longitude information is correct and determine, when determining that the latitude-longitude information is an outlier, that the latitude-longitude information is not correct.

### (Appendix 4)

The providing device according to appendix 2, wherein the processors
acquire a delivery completion list that stores a delivery completion time indicating a time when delivery is completed with respect to each delivery destination,
identify the partial time series including a time series closest to the delivery completion time with respect to each delivery destination, and
associate position information of each position included in the identified partial time series with an address character string of the delivery destination.

### (Appendix 5)

The providing device according to any one of appendices 1 to 4, wherein the processors provide, when the latitude-longitude information is determined not to be correct, delivery-destination map information in which a distribution of the extracted position information is superimposed on a map.

### (Appendix 6)

The providing device according to any one of appendices 1 to 5, wherein the processors
identify, when the latitude-longitude information is determined not to be correct, a parking or stopping position where a vehicle is parked or stopped when a package is delivered to the delivery destination, based on a head piece of position information, the head piece of position information being a piece of position information having an early detection time, the detection time being a time when a position is detected, and an end piece of position information, the end piece of position information being a piece of position information having a late detection time, among the extracted position information,
identify position information farthest from the identified parking or stopping position as a position of the delivery destination, and
provide delivery-destination map information in which each of the identified parking or stopping position and the identified position of the delivery destination is arranged on a map. (Appendix 7)

The providing device according to any one of appendices 1 to 6, wherein the processors provide, when the acquired latitude-longitude information is an area information indicating a geographical area or when the latitude-longitude information associated with the address character string is not acquired, map information in which a position of the accepted address character string is displayed on a map, based on the extracted position information.

### (Appendix 8)

The providing device according to any one of appendices 1 to 7, wherein the processors extract pieces of position information recorded in association with the accepted address character string and remove an outlier from the extracted pieces of position information.

### (Appendix 9)

The providing device according to appendix 1, wherein
the predetermined action is an action of making a completion report to an effect that the deliverer has completed a delivery to each delivery destination, and
the processors
acquire a time series of positions of the deliverer, the positions being detected in a process in which the deliverer delivers a package, and
extract the time series closest to a time when the completion report is made or a delivery completion time that is input in the completion report from the acquired time series,
generate association information associating position information included in the extracted time series with an address character string of the delivery destination, and
store the generated association information in the database.

### (Appendix 10)

A providing method causing a computer to execute processing comprising:
accepting an address character string of a delivery destination of a package;
acquiring latitude-longitude information associated with accepted address character string;
extracting position information recorded in association with accepted address character string from a database that associates an address character string representing a delivery destination a delivery of a package to which is completed with position information of a position where a deliverer who delivered a package to the delivery destination was present when the deliverer performed a predetermined action;
determining, by comparing the acquired latitude-longitude information with extracted position information, whether or not the latitude-longitude information is correct; and
providing, when the latitude-longitude information is determined to be correct, delivery-destination map information in which a position determined based on the latitude-longitude information is displayed on a map and providing, and when the latitude-longitude information is determined not to be correct, delivery-destination map information in which a position of the accepted address character string is displayed on a map, based on extracted position information.

### (Appendix 11)

A non-transitory computer-readable recording medium storing a program for causing a computer to execute processing comprising:
accepting an address character string of a delivery destination of a package;
acquiring latitude-longitude information associated with accepted address character string;
extracting position information recorded in association with accepted address character string from a database that associates an address character string representing a delivery destination a delivery of a package to which is completed with position information of a position where a deliverer who delivered a package to the delivery destination was present when the deliverer performed a predetermined action;
determining, by comparing the acquired latitude-longitude information with extracted position information, whether or not the latitude-longitude information is correct; and
providing, when the latitude-longitude information is determined to be correct, delivery-destination map information in which a position determined based on the latitude-longitude information is displayed on a map and providing, when the latitude-longitude information is determined not to be correct, delivery-destination map information in which a position of the accepted address character string is displayed on a map, based on extracted position information.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

The present disclosure can be suitably employed for a providing device, a providing method, and a program that are capable of providing a position of a delivery destination even when correct position information of the delivery destination cannot be acquired by geocoding.

1. A providing device, comprising one or more processors,
wherein the processors
accept an address character string of a delivery destination of a package,
acquire latitude-longitude information associated with the accepted address character string,
extract position information recorded in association with the accepted address character string from a database that associates an address character string representing a delivery destination a delivery of a package to which is completed with position information of a position where a deliverer who delivered a package to the delivery destination was present when the deliverer performed a predetermined action,
determine, by comparing the acquired latitude-longitude information with the extracted position information, whether or not the latitude-longitude information is correct, and
provide, when the latitude-longitude information is determined to be correct, delivery-destination map information in which a position determined based on the latitude-longitude information is displayed on a map and provide, when the latitude-longitude information is determined not to be correct, delivery-destination map information in which a position of the accepted address character string is displayed on a map, based on the extracted position information.

2. The providing device according to claim 1, wherein
the predetermined action is an action from when the deliverer gets off a vehicle until the deliverer delivers a package to the delivery destination and gets on the vehicle, and
the processors
acquire a time series of positions of the deliverer, the positions being detected in a process in which the deliverer delivers a package,
estimate, from a time when each of the positions included in the acquired time series is detected, movement speed of the deliverer at each of the positions,
extract, based on the estimated movement speed, a partial time series, the partial time series indicating a time section during which the deliverer is estimated not to be on board a vehicle, from the acquired time series, and
generate association information that associates the extracted partial time series with an address character string of the delivery destination to which the deliverer delivered a package and store the generated association information in the database.

3. The providing device according to claim 1, wherein the processors
determine whether or not the acquired latitude-longitude information is an outlier with respect to a distribution of the extracted position information, and determine, when determining that the latitude-longitude information is not an outlier, that the latitude-longitude information is correct and determine, when determining that the latitude-longitude information is an outlier, that the latitude-longitude information is not correct.

4. The providing device according to claim 2, wherein the processors
acquire a delivery completion list that stores a delivery completion time indicating a time when delivery is completed with respect to each delivery destination,
identify the partial time series including a time series closest to the delivery completion time with respect to each delivery destination, and
associate position information of each position included in the identified partial time series with an address character string of the delivery destination.

5. The providing device according to claim 1, wherein the processors provide, when the latitude-longitude information is determined not to be correct, delivery-destination map information in which a distribution of the extracted position information is superimposed on a map.

6. The providing device according to claim 1, wherein the processors
identify, when the latitude-longitude information is determined not to be correct, a parking or stopping position where a vehicle is parked or stopped when a package is delivered to the delivery destination, based on a head piece of position information, the head piece of position information being a piece of position information having an early detection time, the detection time being a time when a position is detected, and an end piece of position information, the end piece of position information being a piece of position information having a late detection time, among the extracted position information,
identify position information farthest from the identified parking or stopping position as a position of the delivery destination, and
provide delivery-destination map information in which each of the identified parking or stopping position and the identified position of the delivery destination is arranged on a map.

7. The providing device according to claim 1, wherein the processors provide, when the acquired latitude-longitude information is an area information indicating a geographical area or when the latitude-longitude information associated with the address character string is not acquired, map information in which a position of the accepted address character string is displayed on a map, based on the extracted position information.

8. The providing device according to claim 1, wherein the processors extract pieces of position information recorded in association with the accepted address character string and remove an outlier from the extracted pieces of position information.

9. The providing device according to claim 1, wherein
the predetermined action is an action of making a completion report to an effect that the deliverer has completed a delivery to each delivery destination, and
the processors
acquire a time series of positions of the deliverer, the positions being detected in a process in which the deliverer delivers a package, and
extract the time series closest to a time when the completion report is made or a delivery completion time that is input in the completion report from the acquired time series, generate association information associating position information included in the extracted time series with an address character string of the delivery destination, and
store the generated association information in the database.

10. A providing method causing a computer to execute processing comprising:
accepting an address character string of a delivery destination of a package;
acquiring latitude-longitude information associated with accepted address character string;
extracting position information recorded in association with accepted address character string from a database that associates an address character string representing a delivery destination a delivery of a package to which is completed with position information of a position where a deliverer who delivered a package to the delivery destination was present when the deliverer performed a predetermined action;
determining, by comparing the acquired latitude-longitude information with extracted position information, whether or not the latitude-longitude information is correct; and
providing, when the latitude-longitude information is determined to be correct, delivery-destination map information in which a position determined based on the latitude-longitude information is displayed on a map and providing, and when the latitude-longitude information is determined not to be correct, delivery-destination map information in which a position of the accepted address character string is displayed on a map, based on extracted position information.

11. A non-transitory computer-readable recording medium storing a program for causing a computer to execute processing comprising:
accepting an address character string of a delivery destination of a package;
acquiring latitude-longitude information associated with accepted address character string;
extracting position information recorded in association with accepted address character string from a database that associates an address character string representing a delivery destination a delivery of a package to which is completed with position information of a position where a deliverer who delivered a package to the delivery destination was present when the deliverer performed a predetermined action;
determining, by comparing the acquired latitude-longitude information with extracted position information, whether or not the latitude-longitude information is correct; and
providing, when the latitude-longitude information is determined to be correct, delivery-destination map information in which a position determined based on the latitude-longitude information is displayed on a map and providing, when the latitude-longitude information is determined not to be correct, delivery-destination map information in which a position of the accepted address character string is displayed on a map, based on extracted position information.
